(19) United States
(12) Patent Application Publication
(10) Pub. No.: US 2005/0268165 A1
(43) Pub. Date: Dec. 1, 2005

(54) Method and system for automated testing of web services

(76) Inventors: Christopher Betts, Victoria (AU); Tony Rogers, Victoria (AU)

Correspondence Address: BAKER BOTTS L.L.P., 2001 ROSS AVENUE, SUITE 600, DALLAS, TX, 75201-2980, US

(21) Appl. No.: 11/134,864

(22) Filed: May 19, 2005

Related U.S. Application Data
(60) Provisional application No. 60/573,503, filed on May 21, 2004.

(51) Int. Cl. G06F 17/30

(52) U.S. Cl. 714/18

(57) ABSTRACT

Method and system for automated testing of web services is provided. A request and a first document comprising an expected response to the request are provided. The request is forwarded to a web service and a response to the forwarded request is received from the web service. A second document comprising the response to the forwarded request is provided. The first document and the second document are compared to determine if the first document and the second document substantially match. A report of the results of the comparison of the first document and the second document is generated.

### REFERENCE TO RELATED APPLICATION

The present disclosure is based on and claims the benefit of Provisional Application Ser. No. 60/573,503 filed May 21, 2004, the entire contents of which are herein incorporated by reference.

### BACKGROUND

1 Technical Field

The present disclosure relates generally to web services and, more particularly, to a method and system for automated testing of web services.

2 Description of the Related Art

Web services are automated resources that can be accessed by the Internet and provide a way for computers to communicate with one another. Web services use “Extensible Markup Language” (XML) to transmit data. XML is a human readable language format that is used for tagging documents that are used by web services. Tagging a document can consist of wrapping specific portions of data in tags that convey a specific meaning, making it easier to locate data and manipulate a document based on these tags.

The more web services are used for business critical applications, the more their functionality, performance, and overall quality become key elements for their acceptance and widespread use. For example, a consumer using a web service will need to be assured that the web service will not fail to return a response in a certain amount of time. Web services should therefore be systematically tested in order to assure their successful performance and operation.

The human readable, text based nature of XML make XML complex and significantly more verbose than other data structures. This results in large data structures with an intricate internal structure. In addition, because it is easy to express the same content in multiple ways using XML, comparing XML documents can also be particularly complex.

Because of the complexities inherent in XML, testing the operation of XML-aware programs often becomes difficult. Some methods of testing include automated testing of XML servers and document based XML testing. However, the general area of automated XML testing is under-developed and existing methods of comparing requests and responses are not particularly user-friendly. In addition, conventional document based XML testing methods are not automated and often require human validation. Human validation of the output of XML aware programs is not only a monotonous and laborious process, but is also highly error prone because tiny errors (for example, differences in the letter case) can easily be missed by the human eye.

Software developers may require the testing of a web service response in order to perform acceptance testing, where functionality that is new to a software release can be tested; and regression testing, where functionality that exists in an older version of a software product can be tested in the new version in order to ensure that performance has not changed. In addition, software developers may use automated testing of software in order to correct performance after any changes to a web service or correct any ill-effects in performance following software, network, and/or system changes.

Accordingly, it would be beneficial to provide a reliable and effective way to automatically test web services with XML aware programs.

### SUMMARY

A method for automated testing of web services includes providing a request, providing a first document comprising an expected response to the request, forwarding the request to a web service, receiving a response to the forwarded request from the web service, providing a second document comprising the response to the forwarded request, comparing the first document to the second document to determine if the first document and the second document substantially match, and generating a report of the results of the comparison of the first document and the second document.

A system for automated testing of web services includes a system for providing a request, a system for providing a first document comprising an expected response to the request, a system for forwarding the request to a web service, a system for receiving a response to the forwarded request from the web service, a system for providing a second document comprising the response to the forwarded request, a system for comparing the first document to the second document to determine if the first document and the second document substantially match, and a system for generating a report of the results of the comparison of the first document and the second document.

A computer recording medium including computer executable code for automated testing of web services, includes code for providing a request, code for providing a first document comprising an expected response to the request, code for forwarding the request to a web service, code for receiving a response to the forwarded request from the web service, code for providing a second document comprising the response to the forwarded request; code for comparing the first document to the second document to determine if the first document and the second document substantially match, and code for generating a report of the results of the comparison of the first document and the second document.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a block diagram of an exemplary computer system capable of implementing the method and system of the present disclosure;

FIG. 2 shows a block diagram illustrating a system for automated testing of web services, according to an embodiment of the present disclosure; and

FIG. 3 shows a flow chart illustrating a method for automated testing of web services, according to an embodiment of the present disclosure; and

### DETAILED DESCRIPTION

The present disclosure provides tools (in the form of methodologies, apparatuses, and systems) for automated testing of web services. The tools may be embodied in one or more computer programs stored on a computer readable medium or program storage device and/or transmitted via a computer network or other transmission medium.

The following exemplary embodiments are set forth to aid in an understanding of the subject matter of this disclosure, but are not intended, and should not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

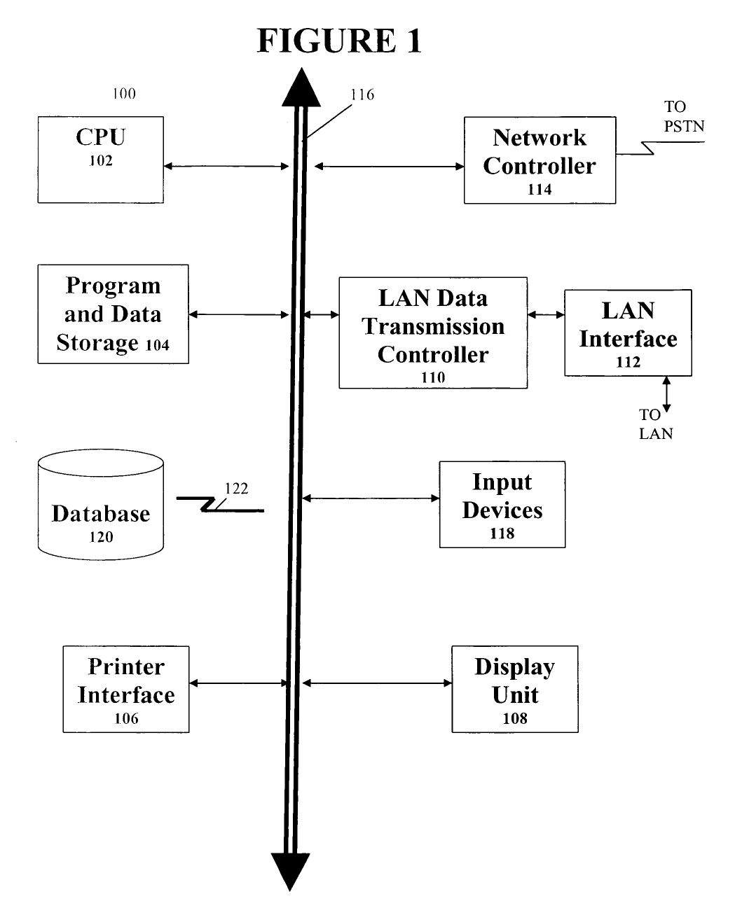

FIG. 1 shows an example of a computer system 100 which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The specific embodiments described herein are illustrative, and many variations can be introduced on these embodiments without departing from the spirit of the disclosure or from the scope of the appended claims. Elements and/or features of different illustrative embodiments may be combined with each other and/or substituted for each other within the scope of this disclosure and appended claims.

Automated testing can be performed for web services using XML aware programs. Two lists of documents can be maintained, where the first list can correspond to a list of request documents and the second list can correspond to a list of expected response documents for each request document. Document(s) as herein referred to include(s) records of web requests and/or web responses. Every time a new feature is added to an XML server, a request document and its corresponding expected response document can be added to a test system. For example, this can be done by creating the request document, observing the response, hand-verifying the response, and then adding it to a list of “approved responses”.

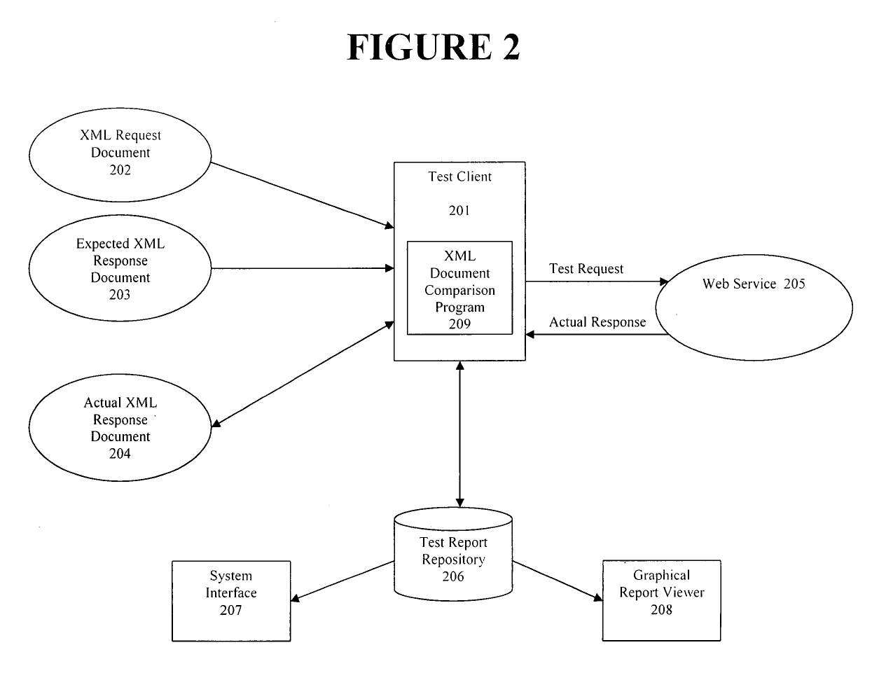

FIG. 2 is a block diagram illustrating a system for automated testing of web services, according to an embodiment of the present disclosure. A test client program 201 can receive an XML request document 202 and its corresponding expected XML response document 203. The XML request(s) can be arranged either as a single document, a directory of documents, and/or a recursive hierarchy of request documents (e.g., in a file system), etc. The expected XML response(s) can be arranged either as a single document, a directory of documents, and/or a recursive hierarchy of response documents (e.g., in a file system), etc. The test client program 201 can then send the XML request document 202 to a web service 205 in order to test its response. Web service 205 will process the XML request document 202 and return an actual response back to test client 201. The actual response can be saved as an actual XML response document 204 in an archive directory for further examination. Once the actual response is received from the web service 205, the test client program 201 can compare the actual XML response document 204 with the expected XML response document 203 using an XML document comparison system or program 209. XML document comparison system 209 will be described in further detail below.

The results of the comparison can be stored in a test report repository 206. If the actual XML response document 204 matches the expected XML response document 203, then a report is generated indicating that the comparison was a success. On the other hand, if the actual XML response document 204 does not match the expected XML response document 203, then a report can be generated indicating that the comparison was a failure and recording additional details, such as the portions of the documents that do not match, the location of the expected response and the actual response for manual comparison, etc.

According to an embodiment of the present disclosure, the test report repository 206 may be included in, or accessed by a larger automated system via system interface 207. In addition, the test report repository 206 can also be viewed by a graphical report viewer 208. The graphical report viewer 208 can include links to the original document for easy access and troubleshooting.

The XML document comparison system 209 can create a data tree corresponding to each document being compared, where the nodes of one tree can be compared with the nodes of another tree (in view of the syntax rules of the node). In this way, white space and other issues, such as capitalization or other syntax dependencies can be avoided. The comparison system 209 may ignore features that are unimportant for XML comparison such as white space. However, if a significant difference between the expected response and the actual response occurs, a failure can be recorded.

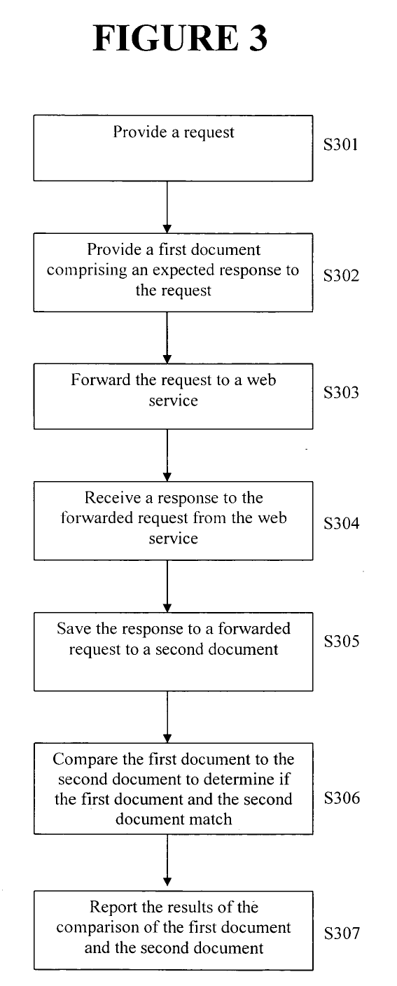

FIG. 3 is a flow chart illustrating a method for automated testing of web services, according to an embodiment of the present disclosure. A request and a first document (or documents) containing an expected response to the request are generated and provided (Steps S301, S302). The request and expected response can be generated by generating the request document, sending it to a web service similar to that for which the request document is designed to test, observing the response from the web service, hand-verifying the response and then adding the response to the list of approved responses (e.g., the expected response documents). The test client can then forward the request document to a web service being tested. (Step S303). The web service being tested will process the request document and prepare and return an actual response to the test client (Step S304). The actual response from the web service can be saved to a second document repository (Step S305). The expected response document can then be compared to the actual response document to determine if there is a substantial match. (Step S306). As noted above, the documents can be compared by using a comparison program, where the comparison program creates a data tree for the expected response document and the actual response document and then compares the two trees. The results of this comparison can then be reported (Step S307).

Numerous additional modifications and variations of the present disclosure are possible in view of the above-teachings. It is therefore to be understood that within the scope of the appended claims, the present disclosure may be practiced other than as specifically described herein.

1. A method for automated testing of web services, comprising:
providing a request;
providing a first document comprising an expected response to the request;
forwarding the request to a web service;
receiving a response to the forwarded request from the web service;
providing a second document comprising the response to the forwarded request;
comparing the first document to the second document to determine if the first document and the second document substantially match; and
generating a report of the results of the comparison of the first document and the second document.

2. The method of claim 1, wherein a document is a record of requests or responses.

3. The method of claim 1, wherein if the first document and the second document substantially match, the generated report indicates that the comparison was a success.

4. The method of claim 1, wherein if the first document and the second document do not substantially match, the generated report indicates that the comparison was a failure and additional details.

5. The method of claim 4, wherein the additional details comprise portions of the first document and the second document that do not match, and a location of the first document and the second document.

6. The method of claim 5, wherein the location is provided by URL or similar reference.

7. The method of claim 1, wherein the first document comprises predetermined responses.

8. The method of claim 1, further comprising providing a third document, wherein the third document comprises the request, and associating the third document with the first document and/or the second document.

9. The method of claim 1, wherein comparing the first document to the second document comprises representing the first document as a first tree, representing the second document as a second tree, and comparing the first tree and the second tree.

10. The method of claim 1, wherein the generated results are saved in a test report repository.

11. The method of claim 10, wherein the test report repository can be accessed by a system interface and/or graphical report viewer.

12. A system for automated testing of web services, comprising:
a system for providing a request;
a system for providing a first document comprising an expected response to the request;
a system for forwarding the request to a web service;
a system for receiving a response to the forwarded request from the web service;
a system for providing a second document comprising the response to the forwarded request;
a system for comparing the first document to the second document to determine if the first document and the second document substantially match; and
a system for generating a report of the comparison of the first document and the second document.

13. The system of claim 12, wherein a document is a record of requests or responses.

14. The system of claim 12, wherein if the first document and the second document substantially match, the generated report indicates that the comparison was a success.

15. The system of claim 12, wherein if the first document and the second document do not substantially match, the generated report indicates that the comparison was a failure and additional details.

16. The system of claim 15, wherein the additional details comprise portions of the first document and the second document that do not match, and the location of the first document and the second document.

17. The system of claim 16, wherein the location is provided by URL or similar reference.

18. The system of claim 12, wherein the first document comprises predetermined responses.

19. The system of claim 12, further comprising a system for providing a third document, wherein the third document comprises the request, and a system for associating the third document with the first document and/or the second document.

20. The system of claim 12, wherein the system for comparing the first document to the second document comprises a system for representing the first document as a first tree, for representing the second document as a second tree, and for comparing the first tree and the second tree.

21. The system of claim 12, wherein the generated results are saved in a test report repository.

22. The system of claim 21, wherein the test report repository can be accessed by a system interface and/or graphical report viewer.

23. A computer recording medium including computer executable code for automated testing of web services, comprising:
code for providing a request;
code for providing a first document comprising an expected response to the request;
code for forwarding the request to a web service;
code for receiving a response to the forwarded request from the web service;
code for providing a second document comprising the response to the forwarded request;
code for comparing the first document to the second document to determine if the first document and the second document substantially match; and
code for generating a report of the results of the comparison of the first document and the second document.

24. The computer recording medium of claim 22, wherein a document is a record of requests or responses.

25. The computer recording medium of claim 23, wherein if the first document and the second document substantially match, the generated report indicates that the comparison was a success.

26. The computer recording medium of claim 23, wherein if the first document and the second document do not substantially match, the generated report indicates that the comparison was a failure and additional details.

27. The computer recording medium of claim 26, wherein the additional details comprise portions of the first document and the second document that do not match, and a location of the first document and the second document.

28. The computer recording medium of claim 27, wherein the location is provided by URL or similar reference.

29. The computer recording medium of claim 23, wherein the first document comprises predetermined responses.

30. The computer recording medium of claim 23, further comprising code for providing a third document, wherein the third document comprises the request, and code for associating the third document with the first document and/or the second document.

31. The computer recording medium of claim 23, wherein the code for comparing the first document to the second document comprises code for representing the first document as a first tree, code for representing the second document as a second tree, and code for comparing the first tree and the second tree.

32. The computer recording medium of claim 23, wherein the generated results are saved in a test report repository.

33. The computer recording medium of claim 32, wherein the test report repository can be accessed by a system interface and/or graphical report viewer.
